(19) United States
(12) Patent Application Publication
(10) Pub. No.: US 2003/0178267 A1
(43) Pub. Date: Sep. 25, 2003

(54) Fluid separator for a shock absorber

(76) Inventor: James D. Doyle, Canton, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/392,695

(22) Filed: Mar. 20, 2003

Related U.S. Application Data
(60) Provisional application No. 60/366,096, filed on Mar. 20, 2002.

(51) Int. Cl. F16F 9/24

(52) U.S. Cl. 188/297

(57) ABSTRACT

A fluid separator and particularly a fluid separator for use in a shock absorber is disclosed. A monotube shock absorber with such fluid separator includes a pressure tube having a generally cylindrical inner surface bounded by a closed end and an open end that defines a chamber, and a piston/valve located within the chamber and defining within the chamber a first fluid cavity and a second fluid cavity. A fluid separator is located within the chamber between the piston/valve and the closed end, including a generally circular ring having a radially outer portion mounted and sealing about a circumference of the inner surface in a generally fixed relationship and a radially inner portion. The fluid separator includes an elastomeric portion having a flexible membrane mounted to and spanning an area within the radially inner portion of the ring to thereby define a gas chamber between the fluid separator and the closed end.

### CROSS REFERENCE TO RELATED APPLICATIONS

This clams the benefit of U.S. provisional patent application identified as Application No. 60/366,096, filed Mar. 20, 2002.

### BACKGROUND OF INVENTION

This invention relates in general to a fluid separator, and more particularly to a monotube type shock absorber having a fluid separator.

A conventional shock absorber is connected between two members in order to damp vibrational forces that might otherwise transfer from one member to another. An example of an application for a shock absorber is one employed in a vehicle suspension. The shock absorber will damp spring oscillations caused by road irregularities, thus reducing the amount of vibrations transferred to the vehicle body. Dampers can also be employed in vehicle struts.

A particular type of shock absorber is a monotube shock absorber. A typical configuration for a conventional monotube shock absorber is one that includes a piston/valve assembly mounted in a pressure tube (also called a compression cylinder), with a piston rod connected to the piston/valve assembly and extending out of the pressure tube. A first end of the pressure tube is closed while a second end includes a piston rod seal assembly, which seals around the piston rod that extends therethrough. The piston/valve assembly creates a boundary between two oil chambers in the pressure tube, with the piston/valve assembly allowing for restricted flow of oil between the two chambers. The closed end of the shock absorber typically connects to a suspension component, such as a suspension control arm, while the piston rod typically connects to a vehicle body or frame.

When a force input is received from the suspension or frame, the rod causes the piston/valve assembly to move telescopically relative to the pressure tube. This results in oil flowing through valve restriction ports in the piston/valve assembly at a controlled rate, thus damping the spring oscillation.

Many of these conventional monotube shock absorbers also include a pressurized gas chamber in the pressure tube, which is employed to help keep the oil pressurized in order to reduce foaming (also called aeration), and also for ride tuning. These types of shock absorbers are commonly referred to as gas-charged shock absorbers. The gas charged, monotube shock includes a separator (also known as a piston) that is located in the pressure tube between the piston valve assembly and the closed end of the shock absorber. The separator is typically made of a stiff, generally cylindrical shaped body, with an elastomeric O-ring mounted about its perimeter in order to seal between the inner surface of the pressure tube and the body. The body is typically made of steel, aluminum or Nylon. While an O-ring is a typical seal, other types of seals are employed that seal around the inner surface while in sliding contact with it. The separator, then, seals the oil chamber, located between the piston/valve assembly and the separator, from a gas chamber, located between the separator and the closed end of the pressure tube. There is typically a hole extending through the wall of the pressure tube into the gas chamber in order to charge the chamber. After charging, the hole is then plugged. Some shocks may employ a charge valve rather than a hole with a plug. A common gas used to charge this chamber is nitrogen.

The separator is designed to be able to move up and down along the inner surface of the pressure tube, with the O-ring sealing along this surface, in order to allow a change the in volume of the oil chamber relative to the gas chamber. If this inner surface, however, becomes scored or has other surface defects, the reciprocation of the O-ring seal over such defects can cause the seal to fail over time. Debris inside of the pressure tube that comes into contact with the seal may also cause the seal to fail over time.

Moreover, for the separator to move along the inner surface, the friction of the O-ring pressing against the inner surface must be overcome, as well as the inertia of the separator mass itself. This is undesirable since the friction from the separator can be felt at the piston rod, and consequently, the vehicle suspension.

Thus, it is desirable to have a separator for use with a gas-charged shock absorber that will adequately seal between a gas chamber and an oil chamber, while minimizing friction and still allowing for a relatively quick variation in volume between the oil chamber and the gas chamber.

### SUMMARY OF INVENTION

In its embodiments, the present invention contemplates a fluid separator for use in a monotube shock absorber having a pressure tube with a generally cylindrical inner surface. The fluid separator includes a generally circular ring having a radially outer portion adapted for mounting and sealing about a circumference of the inner surface in a non-moving relationship, and a radially inner portion; and an elastomeric portion, including a flexible membrane mounted to and spanning an area within the radially inner portion of the ring.

An embodiment of the present invention further contemplates a monotube shock absorber, with the shock absorber including a pressure tube having a generally cylindrical inner surface bounded by a closed end and an open end that defines a chamber, and a piston/valve located within the chamber and defining within the chamber a first fluid cavity and a second fluid cavity. The shock absorber also includes a fluid separator, located within the chamber between the piston/valve and the closed end, including a generally circular ring having a radially outer portion mounted and sealing about a circumference of the inner surface in a generally fixed relationship and a radially inner portion, and with the fluid separator including an elastomeric portion having a flexible membrane mounted to and spanning an area within the radially inner portion of the ring to thereby define a gas chamber between the fluid separator and the closed end.

The present invention further contemplates a method of operating a monotube shock absorber comprising the steps of: filling a first fluid chamber and a second fluid chamber, separated by a piston/valve and defined within an inner surface of a pressure tube, with a liquid; filling a gas chamber, separated from the second fluid chamber by a fluid separator and defined by the inner surface of the pressure tube, with a gas; moving the piston/valve relative to the pressure tube, which thereby creates a volume change in the first and the second fluid chambers; and flexing an inner portion of the fluid separator, to thereby change a relative volume between the first and the second fluid chamber and the gas chamber, while maintaining an outer portion of the fluid separator fixed relative to the inner surface of the pressure tube.

An advantage of the present invention is that seal wear due to the separator sliding along the inner surface of the pressure tube is eliminated. Thus, a longer lasting seal between the oil and gas is achievable. Moreover, seal wear due to debris in the oil is essentially eliminated.

Another advantage of the present invention is reduced friction and moving mass when the separator changes the volume between the oil chamber and the gas chamber since only the flexible membrane moves. The separator seal does not need to slide up and down on the inner surface of the pressure tube, thus reducing friction, and the sealing ring around the perimeter of the separator does not need to move, thus reducing the amount of mass that moves.

### BRIEF DESCRIPTION OF DRAWINGS

FIG. 1 is a cross sectional view of a portion of a monotube shock absorber, with a fluid separator mounted therein, in accordance with an embodiment of the present invention;

FIG. 2 is a cross sectional view similar to FIG. 1, but illustrating a second embodiment of the present invention;

FIG. 3a is a schematic drawing of a fluid separator mounted in a shock absorber pressure tube, with the elastomer generally in its as-molded shape, according to the second embodiment of the present invention;

FIG. 3b is a view similar to FIG. 3a, but illustrating the general shape of the fluid separator after installing a piston/valve/rod guide assembly and oil into the pressure tube;

FIG. 3c is a view similar to FIG. 3b, but illustrating the general shape of the fluid separator during shock absorber operation just as the piston/valve assembly reaches a fully compressed state; and

FIG. 3d is a view similar to FIG. 3c, but illustrating the general shape of the fluid separator when the shock absorber is operating at a high temperature.

### DETAILED DESCRIPTION

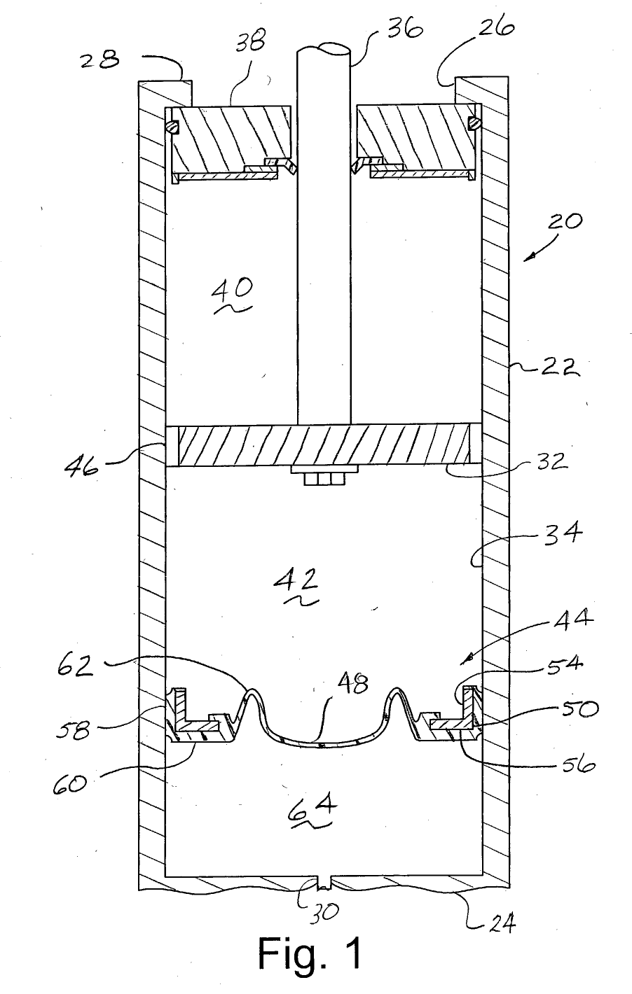

FIG. 1 illustrates a monotube shock absorber, indicated generally as 20. The term “shock absorber,” as used herein, refers to a damper assembly, which also may be employed in vehicle struts. Thus, whenever the term “shock absorber” is used herein, it is defined to include struts as well. The shock absorber 20 includes a hollow, generally cylindrical, pressure tube 22 having a first, closed end 24, and a second, open end 26 with a formed end cap 28. A gas charge port 30 extends through the closed end 24. A shock absorber dust sleeve, and upper and lower shock mounts, are not shown for clarity, but are well known to those skilled in the art.

A piston/valve assembly 32 is mounted to telescopically slide along an inner, cylindrical surface 34 of the pressure tube 22. The piston/valve assembly 32 is connected to a piston rod 36 that extends through the open end 26 of the pressure tube 22. An end cap/seal 38 mounts within the open end 26 and seals around the piston rod 36. The piston/valve assembly 32, then, defines two liquid chambers within the pressure tube 22—a first liquid chamber 40 between the piston/valve assembly 32 and the end cap/seal 38, and a second liquid chamber 42 between the piston/valve assembly 32 and a fluid separator 44. Fluid can flow between the two chambers 40, 42 through restricted orifices 46 in the piston/valve assembly 32 in a manner known to those skilled in the art. The liquid in the first and second liquid chambers 40, 42 is preferably oil, although other suitable liquids may also be employed.

The fluid separator 44 includes a generally circular ring 50, which preferably has an L-shaped cross section with an axial flange 54 and a radial flange 56. The ring 50 is preferably made of a relatively rigid material, such as, for example, steel, aluminum or nylon. An elastomeric material is preferably molded onto the ring 50, forming an axial flange 58, a radial flange 60, and a flexible membrane 62. The elastomeric material is a non-permeable or a low permeability material. Also, the elastomeric material is preferably a synthetic elastomer, such as, for example, a fluoro-elastomer, epichlorohydrin, or a nitrile rubber—although, other suitable elastomeric materials can be employed if so desired.

The thickness of the axial flange 58, which is molded onto the axial flange 54 of the ring 50, is preferably sufficient to cause an interference fit with the inner surface 34 of the pressure tube 22 when the separator 44 is installed in the tube 22. In this way, once installed, the separator 44 will generally not slide axially relative to the pressure tube 22 even during operation of the shock absorber 20, and will seal around the entire circumference of the inner surface. The flexible membrane 62 spans the area bounded by the ring 50, thus forming a complete separation between the second liquid chamber 42 and a gas chamber 64. The gas that is pumped into the gas chamber 64 through the gas charge valve 30 is preferably nitrogen, although other suitable gases may be employed if so desired.

As fluid in the second chamber 42 is displaced by movement of the piston rod 36, the membrane 62 flexes, moving between the second chamber 42 and the gas chamber 64. While the membrane 62 flexes in response to these displacement changes, the ring 50 remains stationary relative to the inner surface 34 of the pressure tube 22. Since it is stationary, the scoring and other problems that may occur with prior art reciprocating separators are eliminated. The separator 44 is now resistant to contamination and debris inside the shock absorber 20. Moreover, friction inside the shock absorber 20 is greatly reduced when compared to a shock absorber with a prior art separator. And, the amount of moving mass is reduced since the membrane 62 has relatively low moving mass compared to a prior art separator.

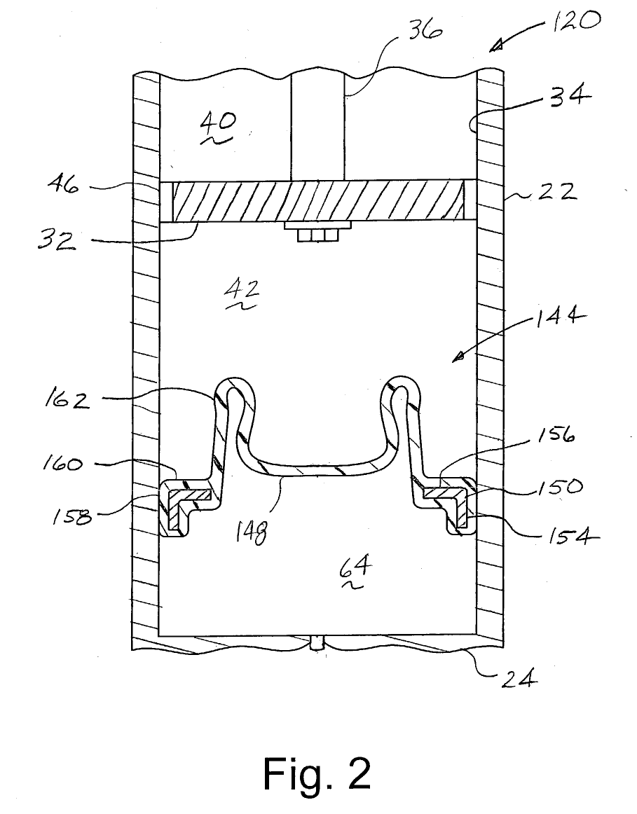

A second embodiment of the present invention is illustrated in FIG. 2, where like elements have the same element numbers as the first embodiment, while changed elements will have 100-series numbers. In this embodiment, the piston/valve assembly 32, rod 36 and pressure tube 22 of the shock absorber 120 are the same, but the fluid separator 144 has changed somewhat. The axial flange 154 of the ring 150 is inverted so that it is extending from the radial flange 156 in a direction that is away from the piston/valve assembly 32. The ring 150, however, still creates an interference fit with the inner surface 34 of the tube 22 as it presses against the axial flange 158 of the elastomeric member 148. And, the radial flange 160 still extends between the axial flange 158 and the flexible membrane 162 in order to seal the fluid chamber 42 from the gas chamber 64. Additionally, in this embodiment, the elastomeric material of the member 148 is shown molded entirely around the ring 150, thus completely encapsulating it—although, the elastomeric material may cover only a portion of the ring 150, if so desired.

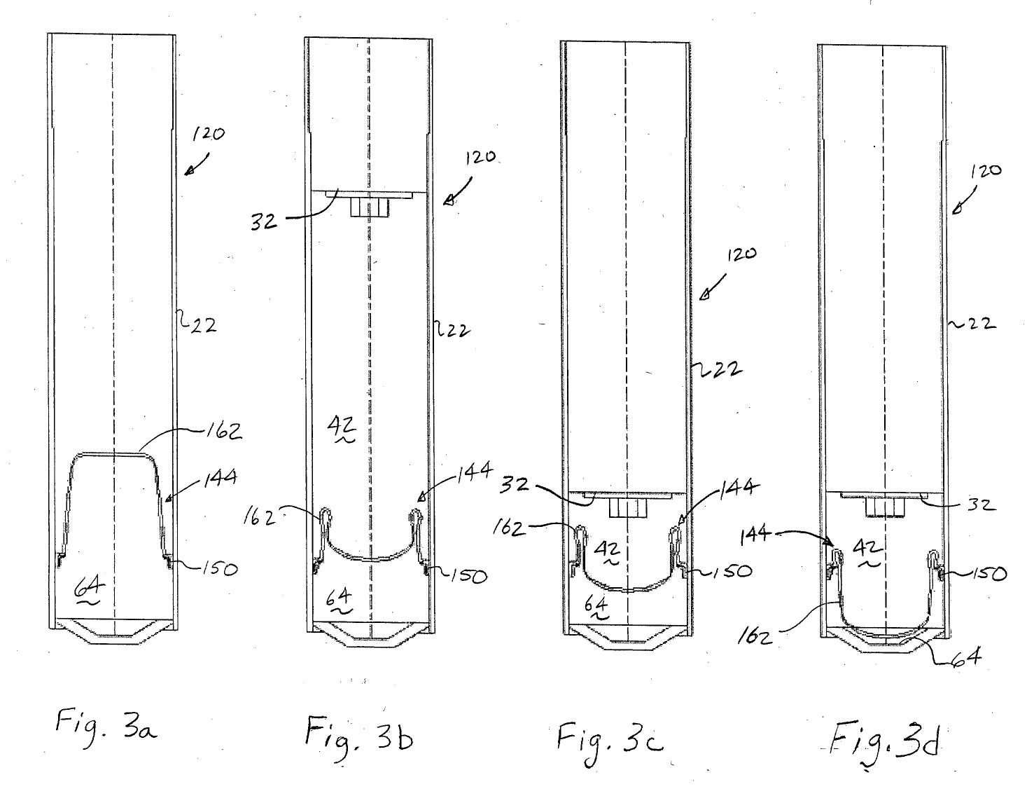

FIGS. 3a-3d are schematic views of a portion of a shock absorber 120 that illustrate the pressure tube 22 and the fluid separator 144 in various states of assembly and operation. While FIGS. 3a-3d are shown employing the second embodiment of the invention, they are equally applicable to the first embodiment as well. FIG. 3a shows the fluid separator 144 mounted with an interference fit within the pressure tube 22, but before the piston/valve/rod guide assembly 32 is installed. So, the flexible membrane 162 is shown in an as-molded shape. It should be noted that, while this shape is a preferred molded shape for the flexible membrane 162, other initial molded shapes may be employed, if so desired, without departing from the scope of the present invention.

FIG. 3b illustrates a general shape of the flexible membrane 162 of the fluid separator 144 after installing the piston/valve/rod guide assembly 32, and rod, as well as the fluid in chamber 42. With the membrane 162 being partially flexed, it can allow for an increase or a decrease in the volume of the gas chamber 64 during operation of the shock absorber 120. FIG. 3c shows a general shape of the flexible membrane 162, during operation of the shock absorber 120, just as the piston/valve assembly 32 reaches a fully compressed shock absorber position. While the flexible membrane 162 has been flexed farther into the gas chamber 64, it is still not fully flexed. One of the reasons for allowing additional flexing is illustrated in FIG. 3d. This figure shows the shock absorber 120 under essentially the same operating conditions as in FIG. 3c, but with the shock absorber 120 operating at a much higher temperature, which causes thermal expansion of the oil. This type of condition typically may occur due to extended driving on very rough roads or during off-road driving. FIGS. 3a-3d, then, illustrate that the fluid separator 144 can operate under the various conditions that the shock absorber 120 encounters without requiring that the fluid separator 144 move relative to the inner surface 34 of the pressure tube 22.

While certain embodiments of the present invention have been described in detail, those familiar with the art to which this invention relates will recognize various alternative designs and embodiments for practicing the invention as defined by the following claims.

What is claimed is:

1. A fluid separator for use in a monotube shock absorber having a pressure tube with a generally cylindrical inner surface, the fluid separator comprising:
a generally circular ring having a radially outer portion adapted for mounting and sealing about a circumference of the inner surface in a generally fixed relationship, and a radially inner portion; and
an elastomeric portion, including a flexible membrane mounted to and spanning an area within the radially inner portion of the ring.

2. The fluid separator of claim 1 wherein the elastomeric portion also includes an axial flange adapted to be located between the radially outer portion of the ring and the inner surface of the pressure tube, to thereby create an interference fit between the fluid separator and the inner surface.

3. The fluid separator of claim 1 wherein the elastomeric portion is molded to the ring.

4. The fluid separator of claim 1 wherein the ring has a generally L-shaped cross section, with the radially outer portion being formed by an axially extending flange and the radially inner portion being formed by a radially extending flange.

5. The fluid separator of claim 1 wherein the ring is formed of one of steel, aluminum, and nylon.

6. The fluid separator of claim 1 wherein the elastomeric membrane is formed of a synthetic elastomer.

7. The fluid separator of claim 1 wherein the elastomeric membrane is formed of one of a fluoro-elastomer, epichlorohydrin, and a nitrile rubber.

8. The fluid separator of claim 1 wherein the elastomeric portion is molded entirely around the ring, thereby encapsulating the ring.

9. The fluid separator of claim 1 wherein the elastomeric portion is generally impermeable to oil and nitrogen.

10. A monotube shock absorber comprising:
a pressure tube having a generally cylindrical inner surface bounded by a closed end and an open end that defines a chamber;
a piston/valve located within the chamber and defining within the chamber a first fluid cavity and a second fluid cavity;
a fluid separator, located within the chamber between the piston/valve and the closed end, including a generally circular ring having a radially outer portion mounted and sealing about a circumference of the inner surface in a generally fixed relationship and a radially inner portion, and with the fluid separator including an elastomeric portion having a flexible membrane mounted to and spanning an area within the radially inner portion of the ring to thereby define a gas chamber between the fluid separator and the closed end.

11. The shock absorber of claim 10 further including a piston rod secured to the piston/valve and extending out of the open end of the pressure tube, and an end cap/seal mounted between the inner surface and the piston rod adjacent to the open end of the pressure tube.

12. The shock absorber of claim 10 wherein the elastomeric portion includes an axial portion located between the radially outer portion of the ring and the inner surface of the pressure tube to thereby create an interference fit between the fluid separator and the inner surface.

13. The shock absorber of claim 10 wherein the elastomeric portion is molded to the ring.

14. The shock absorber of claim 10 wherein the ring has a generally L-shaped cross section, with the radially outer portion being formed by an axially extending flange and the radially inner portion being formed by a radially extending flange.

15. The shock absorber of claim 10 wherein the elastomeric portion is generally impermeable to oil and nitrogen.

16. The shock absorber of claim 10 wherein the elastomeric membrane is formed of a synthetic elastomer.

17. The shock absorber of claim 10 wherein the elastomeric membrane is formed of one of a fluoro-elastomer, epichlorohydrin and a nitrile rubber.

18. A method of operating a monotube shock absorber comprising the steps of:
filling a first fluid chamber and a second fluid chamber, separated by a piston/valve and defined within an inner surface of a pressure tube, with a liquid;
filling a gas chamber, separated from the second fluid chamber by a fluid separator and defined by the inner surface of the pressure tube, with a gas;
moving the piston/valve relative to the pressure tube, which thereby creates a volume change in the first and the second fluid chambers; and
flexing an inner portion of the fluid separator, to thereby change a relative volume between the first and the second fluid chamber and the gas chamber, while maintaining an outer portion of the fluid separator fixed relative to the inner surface of the pressure tube.

19. The method of claim 18 wherein the step of flexing is further defined by flexing an elastomeric membrane that is affixed to the outer portion of the fluid separator.

20. The method of claim 18 wherein the step of flexing is further defined by the outer portion being a generally circular, rigid ring that is fixed relative to the inner surface of the pressure tube.
